(19) United States
(12) Patent Application Publication
(10) Pub. No.: US 2007/0048587 A1
(43) Pub. Date: Mar. 1, 2007

(54) Solid polymer fuel cell

(75) Inventors: Tetsuya Yagi, Tokyo (JP); Tatsunori Okada, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 11/443,001

(22) Filed: May 31, 2006

(30) Foreign Application Priority Data
Aug. 26, 2005 (JP) 2005-246123

(51) Int. Cl. H01M 8/02; H01M 2/08; H01M 8/10; H01M 8/04

(52) U.S. Cl. 429/35; 429/32; 429/38; 429/26

(57) ABSTRACT

A solid polymer fuel cell includes a membrane junction unit being provided an electrolyte membrane sandwiched by an oxidant electrode and a fuel electrode and two separators being sandwiched from both surfaces of the electrolyte membrane, the two separators being provided, in central portions of surfaces of the two separators, with gas flow channels, respectively, and a sealing portions being provided between surfaces of the two separators which are opposed to each other and between surfaces of the two separators which are opposed to the outer peripheral edge portion, respectively, in which the sealed surfaces of the two separators, which are opposed to the sealing portions, respectively, are provided with a plurality of depressions, which are independent of one another in a direction of the sealed surfaces, so that the plurality of depressions surround the gas flow channels.

### BACKGROUND OF THE INVENTION

1. Field of the Invention

The present invention relates to a sealing structure of a solid polymer fuel cell.

2. Description of the Related Art

In a conventional solid polymer fuel cell, with a view to sealing an oxidant electrode and a fuel electrode from the outside, a sealing portion is provided between outer edge portions surrounding those portions of opposed separators which are opposed to the oxidant electrode and the fuel electrode, respectively, and an electrolyte membrane is inserted in an inner peripheral side portion of the sealing portion. Upon application of a fastening load, the sealing portion is excessively pressed in a region thereof in which the electrolyte membrane is sandwiched between the separators, thereby causing an increase in creep and an increase in creep rate. As a result, the oxidant electrode and the fuel electrode cannot be ensured of a required contact pressure, so there is caused a problem in that the performance of the fuel cell deteriorates.

In view of the foregoing, a sealing material dwell groove is formed in a sealed surface of at least one of the two separators that are opposed to each other across the electrolyte membrane. A surplus of the sealing material enters the sealing material dwell groove in a region in which an excessive load is applied to the sealing material. On the contrary, the sealing material does not enter the sealing material dwell groove in a region in which a light load is applied to the sealing material. In consequence, uniform distribution of sealing contact pressure is achieved. Thus, the sealing material is prevented from increasing in creep or in creep rate due to an excessive sealing contact pressure applied only to the region accompanied with the electrolyte membrane, so the performance of the fuel cell is stabilized over a long period of time (e.g., see JP 2002-367631 A).

In order to uniformly distribute the contact pressure applied to the sealed surface of the separator, the sealing material dwell groove is continuously formed in a direction of the sealed surface. Since this groove is continuously formed, there is a space created in the sealing material dwell groove when the amount of the sealing material is smaller than a predetermined amount informing the sealing portion.

On the other hand, a gas flow channel provided in the separator is complicated in shape, thereby causing a great pressure loss. Since the sealing material dwell groove is provided along an outer periphery of the gas flow channel as described above. Therefore, when a space is created in the sealing material dwell groove, the space serves as a channel through which a gas flows. The gas flowing through the channel passes without contributing to a cell reaction. Thus, the amount of the gas supplied to each of the oxidant electrode and the fuel electrode decreases, thereby causing a problem in that the performance of the fuel cell deteriorates or that the distribution of temperature in a cell surface deteriorates.

When a large amount of the sealing material is applied so as to prevent creation of a space in the sealing material dwell groove, the sealing material flows into the gas flow channel across the sealing portion, so the gas flow channel is either reduced in flow channel cross-sectional area or closed. As a result, the flow of the gas is not uniformly distributed, thereby causing a problem in that the performance of the fuel cell deteriorates.

### SUMMARY OF THE INVENTION

It is an object of the present invention to provide a solid polymer fuel cell with a uniformly distributed sealing contact pressure, which is equipped with an oxidant electrode and a fuel electrode to which a constant amount of gas is supplied respectively.

A solid polymer fuel cell according to the present invention includes: a plurality of cells each equipped with a membrane junction unit including an electrolyte membrane, an oxidant electrode, and a fuel electrode, two separators, and sealing portions, a portion of the electrolyte membrane, exclusive of an outer peripheral edge portion of the electrolyte membrane, being sandwiched from both surfaces of the electrolyte membrane by the oxidant electrode and the fuel electrode, respectively, to form the membrane junction unit the membrane junction unit being sandwiched from both surfaces of the membrane junction unit by the two separators, the two separators being provided, in central portions of surfaces of the two separators, with gas flow channels, respectively, and the sealing portions being provided between surfaces of the two separators which are opposed to each other and between surfaces of the two separators which are opposed to the outer peripheral edge portion, respectively, in which the sealed surfaces of the two separators, which are opposed to the sealing portions, respectively, are provided with a plurality of depressions, which are independent of one another in a direction of the sealed surfaces, so that the plurality of depressions surround the gas flow channels.

The solid polymer fuel cell according to the present invention achieves the following effect. The depressions are each independent of one another in the directions in which the gases flow respectively even if the depressions are not filled with the sealing material constituting the sealing portion, so the gases flowing into those ones of the depressions which are not filled with the sealing material flow by the lengths of the depressions, respectively, and return again to the fuel electrode and the oxidant electrode, respectively. As a result, the gases can be prevented from flowing through any region irrelevant to the oxidant electrode or the fuel electrode.

### BRIEF DESCRIPTION OF THE DRAWINGS

In the accompanying drawings:

FIG. 1 is a partial sectional view of a solid polymer fuel cell according to a first embodiment of the present invention;

FIG. 2 is a plan view of a separator according to the first embodiment of the present invention;

FIG. 3 is a sectional view taken along the line A-A of FIG. 2;

FIG. 4 is a view showing a sealing material application region of the separator shown in FIG. 2;

FIG. 5 is a plan view of a separator according to a second embodiment of the present invention; and

FIG. 6 is a plan view of a separator according to a third embodiment of the present invention.

### DETAILED DESCRIPTION OF THE PREFERRED EMBODIMENTS

### First Embodiment

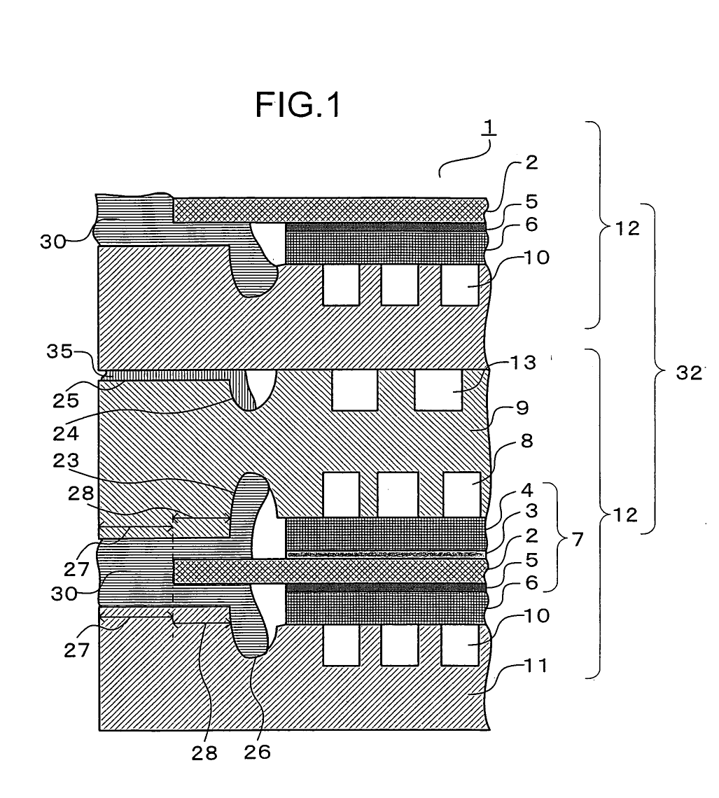

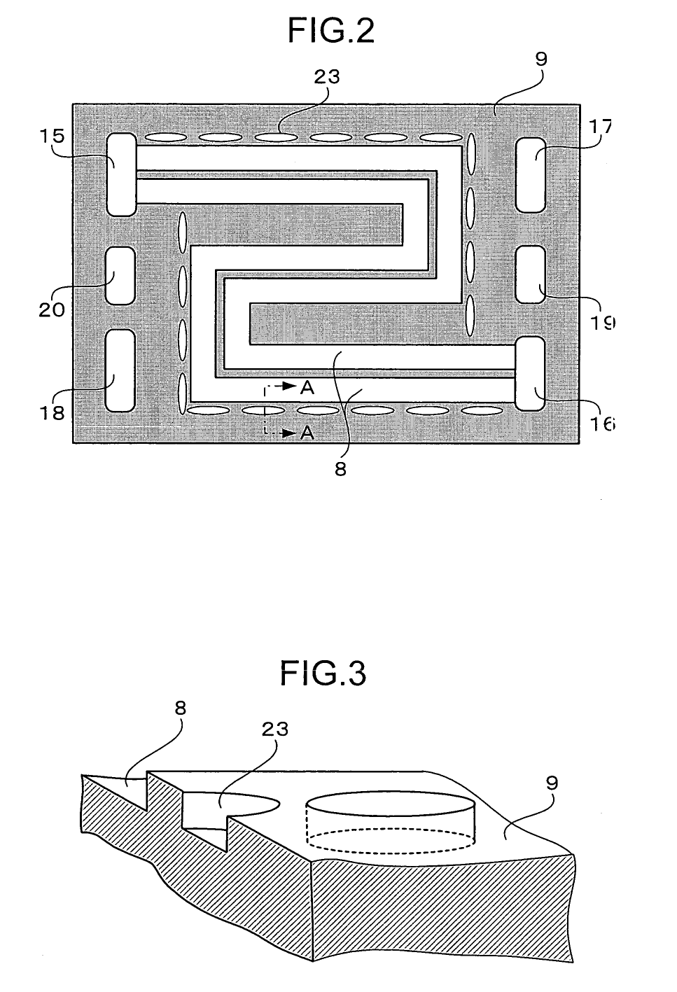

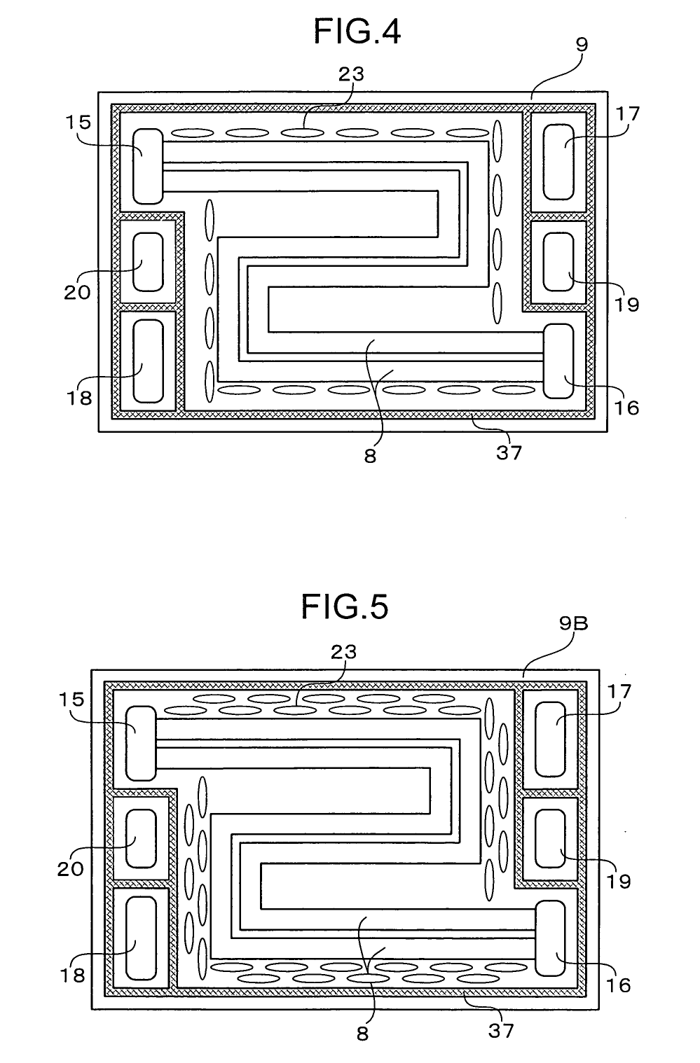

FIG. 1 is a partial sectional view of a solid polymer fuel cell according to a first embodiment of the present invention. FIG. 2 is a plan view of a separator according to the first embodiment of the present invention. FIG. 3 is a sectional view taken along the line A-A of FIG. 2. FIG. 4 is a view showing a sealing material application region of the separator shown in FIG. 2.

As shown in FIG. 1, a solid polymer fuel cell 1 according to the first embodiment of the present invention is equipped with a membrane electrode junction unit 7 including an electrolyte membrane 2, a fuel electrode 4, and an oxidant electrode 6. The electrolyte membrane 2 is made of an ion-exchange membrane. On one surface of the fuel electrode 4, there is formed a catalytic layer 3, which is disposed in contact with a central portion of one surface of the electrolyte membrane 2. On one surface of the oxidant electrode 6, there is formed a catalytic layer 5, which is disposed in contact with a central portion of the other surface of the electrolyte membrane 2.

The solid polymer fuel cell 1 is equipped with a cell 12 including the membrane electrode junction unit 7, a fuel gas separator 9, and an oxidant gas separator 11. In a central portion of one surface of the fuel gas separator 9, there are formed fuel gas flow channels 8 for supplying a fuel gas to the fuel electrode 4, which are disposed facing one surface of the membrane electrode junction unit 7. In a central portion of one surface of the oxidant gas separator 11, there are formed oxidant gas flow channels 10 for supplying an oxidant gas to the oxidant electrode 6, which are disposed facing the other surface of the membrane electrode junction unit 7.

Coolant flow channels 13 are formed in a central portion of the other surface of the fuel gas separator 9, which is opposite to the surface thereof in which the fuel gas flow channels 8 are formed. Although the coolant flow channels 13 are formed in the fuel gas separator 9, they may be formed in the oxidant gas separator 11 or in both the fuel gas separator 9 and the oxidant gas separator 11.

As shown in FIG. 2, the fuel gas separator 9 is provided with a fuel supplying manifold 15, a fuel discharging manifold 16, an oxidant supplying manifold 17, an oxidant discharging manifold 18, a coolant supplying manifold 19, and a coolant discharging manifold 20. Those manifolds pass through the fuel gas separator 9 in a thickness direction thereof. The fuel gas flow channels 8 are each connected at both ends thereof to the fuel supplying manifold 15 and the fuel discharging manifold 16, respectively, on the surface of the fuel gas separator 9 in which the fuel gas flow channels 8 are formed.

A plurality of depressions 23 surrounding the fuel gas flow channels 8 are formed in the surface of the fuel gas separator 9 in which the fuel gas flow channels 8 are formed. As shown in FIG. 3, the depressions 23 assume a rectangular cross-sectional shape in the thickness direction of the fuel gas separator 9, and an elliptical planar shape in a direction of a sealed surface of the fuel gas separator 9. The depressions 23 are independent of one another in that no fluid flows between any adjacent ones of the depressions 23 when their openings are closed on the sealed surface. The depressions 23 are used in the same sense as independent holes used in the expression of a porous body.

Although the independent depressions 23 described above assume a rectangular cross-sectional shape in the thickness direction of the fuel gas separator 9 and an elliptical planar shape in the direction of the sealed surface of the fuel gas separator 9, they may assume a semicircular, triangular, polygonal, or curved cross-sectional shape and a rectangular or circular planar shape instead.

The coolant flow channels 13 are each connected at both ends thereof to the coolant supplying manifold 19 and the coolant discharging manifold 20, respectively, on the surface of the fuel gas separator 9 in which the coolant flow channels 13 are formed. In addition, a plurality of depressions 24 surrounding the coolant flow channels 13 are formed in the surface of the fuel gas separator 9 in which the coolant flow channels 13 are formed. As is the case with the depressions 23, the depressions 24 are also independent of one another. Moreover, the fuel gas separator 9 has an engraved outer peripheral edge portion 25 surrounding the depressions 24. The outer peripheral edge portion 25 is reduced in thickness in comparison with the rest of the fuel gas separator 9.

Although not shown, the oxidant gas separator 11 is provided with an oxidant supplying manifold, an oxidant discharging manifold, a fuel supplying manifold, a fuel discharging manifold, a coolant supplying manifold, and a coolant discharging manifold. Those manifolds, which are located at the same positions as the manifolds of the fuel gas separator 9 respectively when the oxidant gas separator 11, the fuel gas separator 9, and the membrane electrode junction unit 7 are assembled into the cell 12, pass through the oxidant gas separator 11 in a thickness direction thereof. The oxidant gas flow channels 10 are each connected at both end thereof to the oxidant supplying manifold and the oxidant discharging manifold, respectively, on the surface of the oxidant gas separator 11 in which the oxidant gas flow channels 10 are formed. Moreover, as is the case with the fuel gas separator 9, a plurality of depressions 26 surrounding the oxidant gas flow channels 10 are formed in the surface of the oxidant gas separator 11 in which the oxidant gas flow channels 10 are formed. As is the case with the depressions 23, the depressions 26 are also independent of one another.

The cell 12 according to the first embodiment of the present invention has a sealing portion 30, which is located between A sealed surfaces 27 of the fuel gas separator 9 and the oxidant gas separator 11 and between B sealed surfaces 28 of the fuel gas separator 9 and the oxidant gas separator 11. While the A sealed surfaces 27 are opposed to each other directly, the B sealed surfaces 28 are opposed to each other via the electrolyte membrane 2. The sealing portion 30 serves to prevent the oxidant gas and the fuel gas from coming into direct contact with each other, and also, to prevent them from leaking to the outside.

In the course of providing the sealing portion 30, a sealing material constituting the sealing portion 30 flows into the depressions 23 and 26 to fill them entirely or partially. This part of the sealing material filling the depressions 23 and 26 entirely or partially is also included in the sealing portion 30.

The solid polymer fuel cell 1 according to the first embodiment of the present invention is equipped with a stack 32 including a plurality of cells 12. A coolant sealing portion 35 is provided between the outer peripheral edge portion 25 of the fuel gas separator 9 of a certain cell 12 and that surface of the oxidant gas separator 11 of another cell 12 adjacent to the cell 12 which surfaces the outer peripheral edge portion 25. The coolant sealing portion 35 serves to prevent a coolant from leaking through a gap.

In the course of forming the coolant sealing portion 35, a sealing material constituting the coolant sealing portion 35 flows into the depressions 24 to fill them entirely or partially. This part of the sealing material filling the depressions 24 entirely or partially is also included in the coolant sealing portion 35.

Next, a method of forming the sealing portion 30 will be described. The following description handles a method of constructing the cell 12. A method of constructing the stack 32 is similar thereto and thus will not be described below.

The sealing material is applied to a sealing material application region 37 of the fuel gas separator 9 shown in FIG. 4. The sealing material application region 37 surrounds the depressions 23, the fuel supplying manifold 15, the fuel discharging manifold 16, the oxidant supplying manifold 17, the oxidant discharging manifold 18, the coolant supplying manifold 19, and the coolant discharging manifold 20. Similarly, the sealing material is applied to a sealing material application region of the oxidant gas separator 11 as well. The sealing material application region of the oxidation gas separator 11 is designed in the same manner as the sealing material application region 37 of the fuel gas separator 9.

Next, the fuel gas separator 9 to which the sealing material has been applied and the oxidant gas separator 11 to which the sealing material has been applied are superposed on the membrane electrode junction unit 7, which is disposed horizontally, from above and below respectively, such that the surfaces to which the sealing material has been applied become opposed to each other.

Next, the fuel gas separator 9, the membrane electrode junction unit 7, and the oxidant gas separator 11, which have been superposed on one another as described above, are pressed from above and below. At this moment, the sealing material increases in area in accordance with a decrease in height. The sealing material that spreads toward the depressions 23 and 26, flows thereinto.

Next, the sealing material is heated under pressure to be cured, and formation of the sealing portion 30 is then completed.

The sealing portion 30 formed as described above is designed such that a dispersion of the application amount of the sealing material and a dispersion of the dimension of each component are absorbed by the amount of the sealing material flowing into the depressions 23 and 26, and that the sealing material does not spread inwardly of the depressions 23 and 26. Therefore, the sealing material does not close the fuel gas flow channels 8 or the oxidant gas flow channels 10.

The depressions 23 and 26 that are only partially filled with the sealing material are each independent of one another, and the gases flowing through the depressions 23 and 26 return to the sealed surfaces across borders of the depressions 23 and 26, respectively. Thus, those supplied gases which have temporarily flowed through the depressions 23 and 26, respectively, also return to the oxidant electrode 6 and the fuel electrode 4, respectively, and contribute to a cell reaction, thereby enabling stabilization of the performance of the fuel cell.

The solid polymer fuel cell 1 according to the present invention achieves the following effects. The depressions 23 and 26 are each independent of one another in the directions in which the gases flow respectively even if the depressions 23 and 26 are not filled with the sealing material constituting the sealing portion 30, so the gases flowing into those ones of the depressions 23 and 26 which are not filled with the sealing material flow by the lengths of the depressions 23 and 26, respectively, and return again to the oxidant electrode 6 and the fuel electrode 4, respectively. As a result, the gases can be prevented from flowing through any region irrelevant to the oxidant electrode 6 or the fuel electrode 4.

The depressions 24 surrounding the coolant flow channels 13 are formed in the surface of the fuel gas separator 9 in which the coolant flow channels 13 are provided, so the dispersion of spread of the sealing material can be absorbed. Further, those ones of the depressions 24 which are not filled with the sealing material are independent of one another, so the coolant that has flowed into the depressions 24 also returns to the coolant flow channels 13. As a result, the fuel electrode 4 and the oxidant electrode 6, which generate heat through the cell reaction, can be cooled directly from below.

Formation of the depressions 23 and 26 ensures that a surplus of the sealing material enters the depressions 23 and 26 in a region of the sealing portion 30 to which an excessive load is applied, and conversely, that the sealing material does not enter the depressions 23 and 26 in a region of the sealing portion 30 to which a light load is applied. Consequently, uniform distribution of the sealing contact pressure is achieved.

Although the depressions 23 and 26 are formed in the fuel gas separator 9 and the oxidant gas separator 11, respectively, in the first embodiment of the present invention as described above, effects similar to those of the solid polymer fuel cell 1 according to the first embodiment of the present invention are achieved even if the depressions 23 and 26 are formed in the membrane electrode junction unit 7.

Effects similar to those of the solid polymer fuel cell 1 according to the first embodiment of the present invention are achieved even if the depressions 23 are formed in both the fuel gas separator 9 and the membrane electrode junction unit 7 and the depressions 26 are formed in both the oxidant gas separator 11 and the membrane electrode junction unit 7.

No parallel gas flow channels are formed in the sealing material application region 37, so there is no possibility of the sealing material flowing into any gas flow channel. Therefore, no depression needs to be formed in the sealing material application region 37.

Although the fuel gas separator 9 and the oxidant gas separator 11 are constructed as two sheet members in the first embodiment of the present invention, they may be replaced with a single sheet member that is provided on both surfaces thereof with a fuel gas flow channel and an oxidant gas flow channel, respectively. Even in this case, effects similar to those of the first embodiment of the present invention are achieved by providing the single sheet member with depressions surrounding those flow channels.

### Second Embodiment

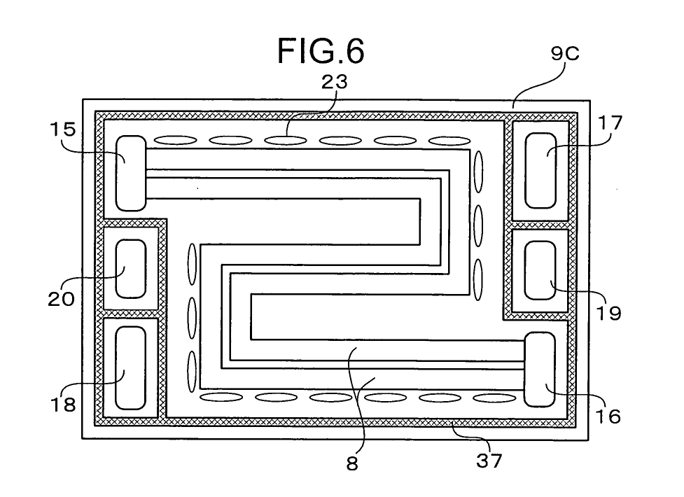

FIG. 5 is a plan view of a fuel gas separator according to a second embodiment of the present invention.

A solid polymer fuel cell according to the second embodiment of the present invention is different in the construction of a fuel gas separator 9B from the solid polymer fuel cell 1 according to the first embodiment of the present invention. They are identical to each other in other constructional details, so like components are denoted by like reference symbols, and the description thereof will be omitted.

As shown in FIG. 5, the fuel gas separator 9B according to the second embodiment of the present invention is different in arrangement of the depressions 23 from the fuel gas separator 9 according to the first embodiment of the present invention. They are identical to each other in other constructional details, so like components are denoted by like reference symbols, and the description thereof will be omitted.

The plurality of the depressions 23, which are independent of one another, are formed in the fuel gas separator 9B in a plurality of rows. The depressions 23 in one of the rows and the depressions 23 in another one of the rows adjacent thereto are arranged alternately. The depressions 23 thus arranged surround the fuel gas flow channels 8.

In the solid polymer fuel cell constructed as described above, the depressions 23 are formed in the plurality of the rows, and the depressions 23 in one of the rows and the depressions 23 in another one of the rows adjacent thereto are arranged alternately. Even when the sealing material flows toward the fuel gas flow channels 8, the depressions 23 exist in that direction. Therefore, the sealing material can be prevented from flowing into the fuel gas flow channels 8.

In the fuel gas separator 9B according to the second embodiment of the present invention, the depressions 23, which are independent of one another, are formed in the plurality of the rows, and the depressions 23 in one of the rows and the depressions 23 in another one of the rows adjacent thereto are arranged alternately. However, the sealing material can be more reliably prevented from flowing into the fuel gas flow channels 8 by increasing the number of the rows in which the depressions 23 are arranged.

In the solid polymer fuel cell according to the second embodiment of the present invention, the depressions 23 in the fuel gas separator 9B are arranged in two rows. However, the sealing material can be prevented from flowing into the oxidant gas flow channels 10 by arranging depressions in the oxidant gas separator 11 in a plurality of rows.

The sealing material can also be prevented from flowing into the coolant flow channels 13 by arranging the depressions 24 provided in the fuel gas separator 9B in a plurality of rows.

### Third Embodiment

FIG. 6 is a plan view of a fuel gas separator according to a third embodiment of the present invention.

A solid polymer fuel cell according to the third embodiment of the present invention is different in the construction of a fuel gas separator 9C from the solid polymer fuel cell 1 according to the first embodiment of the present invention. They are identical to each other in other constructional details, so like components are denoted by like reference symbols, and the description thereof will be omitted.

As shown in FIG. 6, the fuel gas separator 9C according to the third embodiment of the present invention is different in positions where the depressions 23 are provided from the fuel gas separator 9 according to the first embodiment of the present invention. They are identical to each other in other constructional details, so like components are denoted by like reference symbols, and the description thereof will be omitted.

In the fuel gas separator 9C, the depressions 23 are not formed in regions in which a difference in pressure is generated between the two parallel fuel gas flow channels 8.

In the solid polymer fuel cell constructed as described above, the depressions 23 are not formed in the vicinity of those regions of the fuel gas flow channels 8 in which a great pressure loss is caused. Therefore, the fuel gas can be caused to flow directly into the fuel gas flow channels 8.

In the solid polymer fuel cell according to the third embodiment of the present invention, the fuel gas separator 9C is provided with the depressions 23 except in the vicinity of those regions of the fuel gas flow channels 8 in which a great pressure loss is caused. However, the oxidant gas can be caused to flow directly into the oxidant gas flow channels 10 by providing the oxidant gas separator 11 with the depressions 26 except in the vicinity of those regions of the oxidant gas flow channels 10 in which a great pressure loss is caused.

The coolant can be caused to flow directly into the coolant flow channels 13 by providing the fuel gas separator 9 with the depressions 24 except in the vicinity of those regions of the coolant flow channels 13 in which a great pressure loss is caused.

1. A solid polymer fuel cell comprising:
a plurality of cells, each cell including
a membrane junction unit including an electrolyte membrane, an oxidant electrode, and a fuel electrode,
two separators, and
sealing portions, wherein
a portion of each electrolyte membrane, exclusive of an outer peripheral edge portion of the electrolyte membrane, is sandwiched at opposite surfaces of the electrolyte membrane by the oxidant electrode and the fuel electrode, respectively, to form the membrane junction unit
the membrane junction unit is sandwiched at opposite surfaces of the membrane junction unit by the two separators,
the two separators include, in central portions of surfaces of the two separators, respective gas flow channels,
the sealing portions are located between surfaces of the two separators which are opposed to each other and between surfaces of the two separators which are opposed to the outer peripheral edge portion, respectively, and
sealed surfaces of the two separators, which are opposed to the sealing portions, respectively, include a plurality of first depressions, which are independent of one another in a direction of the sealed surfaces, so that the plurality of first depressions surrounds the gas flow channels.

2. The solid polymer fuel cell according to claim 1, wherein at least one of the two separators includes, in a central portion of a surface of the separator which is opposite to the surface in which the gas flow channel is located, a coolant flow channel, and includes, in the surface of the separator in which the coolant flow channel is located, a plurality of second depressions, which are independent of one another, so that the plurality of second depressions surrounds the coolant flow channel.

3. The solid polymer fuel cell according to claim 1, wherein:
the plurality of first depressions are arranged in a plurality of rows; and
the plurality of first depressions in one of the rows and the plurality of first depressions in another one of the rows adjacent to each other are arranged alternately.

4. The solid polymer fuel cell according to claim 1, wherein the plurality of first depressions are located in the sealed surfaces, except proximate portions of the gas flow channels in which a large pressure loss occurs.
